(19) United States
(12) Patent Application Publication
(10) Pub. No.: US 2012/0239729 A1
(43) Pub. Date: Sep. 20, 2012

(54) METHODS AND APPARATUS FOR CONNECTING A THIN CLIENT TO A VIRTUAL DESKTOP

(75) Inventor: Jonathan S. Hefter, Woodmere, NY (US)

(73) Assignee: Neverware, Inc., New York, NY (US)

(21) Appl. No.: 13/231,169

(22) Filed: Sep. 13, 2011

Related U.S. Application Data
(60) Provisional application No. 61/382,357, filed on Sep. 13, 2010.

(51) Int. Cl. G06F 15/16

(52) U.S. Cl. 709/203

(57) ABSTRACT

In some embodiments, an apparatus includes a boot module, a server module, and a broker module within a housing. The boot module is configured to receive a boot request signal from a thin client device. The boot module is configured to send, in response to the boot request signal, a thin client operating system image to the thin client device such that the thin client device can execute a thin client operating system associated with the thin client operating system image. The server module is configured to execute a set of virtual desktops. The broker module is configured to receive, from the thin client operating system executing at the thin client device, a virtual desktop request signal including an identifier of a virtual desktop. The broker module is configured to initiate, based on the identifier, a communication session between the virtual desktop and the thin client operating system.

### CROSS-REFERENCE TO RELATED APPLICATIONS

This application claims priority to and the benefit of U.S. Provisional Patent Application No. 61/382,357, filed Sep. 13, 2010, and entitled “A Server Appliance Capable of Utilizing Computers on a Network as Thin Clients and Connecting Them to Virtual Desktops,” which is incorporated herein by reference in its entirety.

### BACKGROUND

Some embodiments described herein relate generally to computer architectures, and, in particular, to methods and apparatus for connecting a thin client to a virtual desktop within a computer architecture.

In some known computer architectures, a personal computer can be used to provide services, process requested operations, and handle user input and output for a client. Such a personal computer is typically a combination of a central computer and a terminal, built as a single device. Such a personal computer, however, is typically not used to concurrently process the requested operations of a large number of clients. In that case, to ensure each user a separate work environment from peers, a large number of personal computers could be used to satisfy the user demands, which is not cost-efficient.

Accordingly, a need exists for concurrently processing requested operations for multiple clients in an efficient manner.

### SUMMARY

In some embodiments, an apparatus includes a boot module, a server module, and a broker module within a housing. The boot module is configured to receive a boot request signal from a thin client device. The boot module is configured to send, in response to the boot request signal, a thin client operating system image to the thin client device such that the thin client device can execute a thin client operating system associated with the thin client operating system image. The server module is configured to execute a set of virtual desktops. The broker module is configured to receive, from the thin client operating system executing at the thin client device, a virtual desktop request signal including an identifier of a virtual desktop. The broker module is configured to initiate, based on the identifier, a communication session between the virtual desktop and the thin client operating system.

### BRIEF DESCRIPTION OF THE DRAWINGS

FIG. 1 is a schematic illustration of a server device operatively coupled to multiple thin client devices, according to an embodiment.

FIG. 2 is a schematic illustration of the inner structure of a server device, according to an embodiment.

FIG. 3 is a schematic illustration of a database implemented within a server device, according to an embodiment.

FIGS. 4-7 are schematic illustrations of a user interface, according to an embodiment.

FIG. 8 is a schematic illustration of interaction between a thin client device and a server device, according to an embodiment.

FIG. 9 is a flow chart that illustrates a method for booting a thin client device through a server device, according to an embodiment.

### DETAILED DESCRIPTION

In some embodiments, an apparatus includes a boot module, a server module, and a broker module executed at a common hypervisor within a housing. The boot module is configured to receive a boot request signal from a thin client device. The boot module is configured to send, in response to the boot request signal, a thin client operating system image to the thin client device. As a result, the thin client device can execute a thin client operating system associated with the thin client operating system image. In some embodiments, the boot module is configured to receive the boot request signal from the thin client device having as its only nonvolatile memory a nonvolatile basic input/output system (BIOS) memory. In some embodiments, the boot request signal is a Preboot Execution Environment (PXE) boot request signal. In some embodiments, the boot module is configured to send the thin client operating system image to the thin client device via Trivial File Transfer Protocol (TFTP). In some embodiments, the boot module is configured to send the thin client operating system image to the thin client device such that the thin client device can store the thin client operating system image in a volatile memory at the thin client device.

The server module is configured to execute a set of virtual desktops. The broker module is configured to receive, from the thin client operating system executing at the thin client device, a virtual desktop request signal. The virtual desktop request signal includes an identifier of a virtual desktop from the set of virtual desktops. The broker module is configured to initiate, based on the identifier, a communication session between the virtual desktop at the server module and the thin client operating system executing at the thin client device. In some embodiments, the identifier of the virtual desktop is an identifier associated with a user of the thin client device.

In some embodiments, the apparatus includes a Dynamic Host Configuration Protocol (DHCP) server module within the housing. The DHCP server module is configured to receive a DHCP request signal from the thin client device prior to the boot module receiving the boot request signal. The DHCP server module is configured to send, in response to the DHCP request signal, an Internet Protocol (IP) address associated with the thin client device and an IP address associated with the boot module to the thin client device.

In some embodiments, the apparatus further includes a control module within the housing. The control module is configured to manage at least one of the boot module, the server module or the broker module. The control module is configured to provide a user interface (UI) to a user such that the user can manage the boot module, the server module or the broker module using the UI. In some embodiments, the UI can be part of one of a webpage, an application, or the thin client operating system.

In some embodiments, a non-transitory processor-readable medium stores code representing instructions to cause a processor to receive, at a server device, a boot request signal from a thin client device. The code represents instructions to cause the processor to send, in response to the boot request signal, from the server device, a thin client operating system image to the thin client device. As a result, the thin client device can execute a thin client operating system associated with the thin client operating system image. The code also represents instructions to cause the processor to receive, at the server device, a virtual desktop request signal from the thin client operating system. The virtual desktop request signal includes an identifier of a virtual desktop from a set of virtual desktops at the server device. The code further represents instructions to cause the processor to initiate the virtual desktop at the server device, and initiate a communication session between the virtual desktop at the server device and the thin client operating system.

In some embodiments, the boot request signal is a PXE boot request signal. In some embodiments, the code to cause the processor to send the thin client operating system image includes code to cause the processor to send the thin client operating system image to the thin client device via TFTP. In some embodiments, the code represents instructions to cause the processor to receive, at the server device, a DHCP request signal from the thin client device. The code also represents instructions to cause the processor to send, in response to the DHCP request signal, an IP address associated with the thin client device.

As used herein, a thin client device and/or a thin client can refer to any device used to connect to a server running a virtual desktop. For example, a thin client device can be an electronic device (e.g. personal computer (PC), tablet computer, mobile phone, etc.) repurposed from the use accessing a virtual desktop running on a server. In some embodiments, such an electronic device can include an internal hard drive and/or other nonvolatile memory. In other embodiments, for example, such an electronic device can include a nonvolatile basic input/output system (BIOS) memory as its only nonvolatile memory. For another example, a thin client device can be any device configured and/or manufactured to be used specifically as a thin client. For yet another example, a thin client device can be any device used as both a traditional PC and a thin client.

As used in this specification, the singular forms “a,” “an” and “the” include plural referents unless the context clearly dictates otherwise. Thus, for example, the term “a module” is intended to mean a single module or a combination of modules.

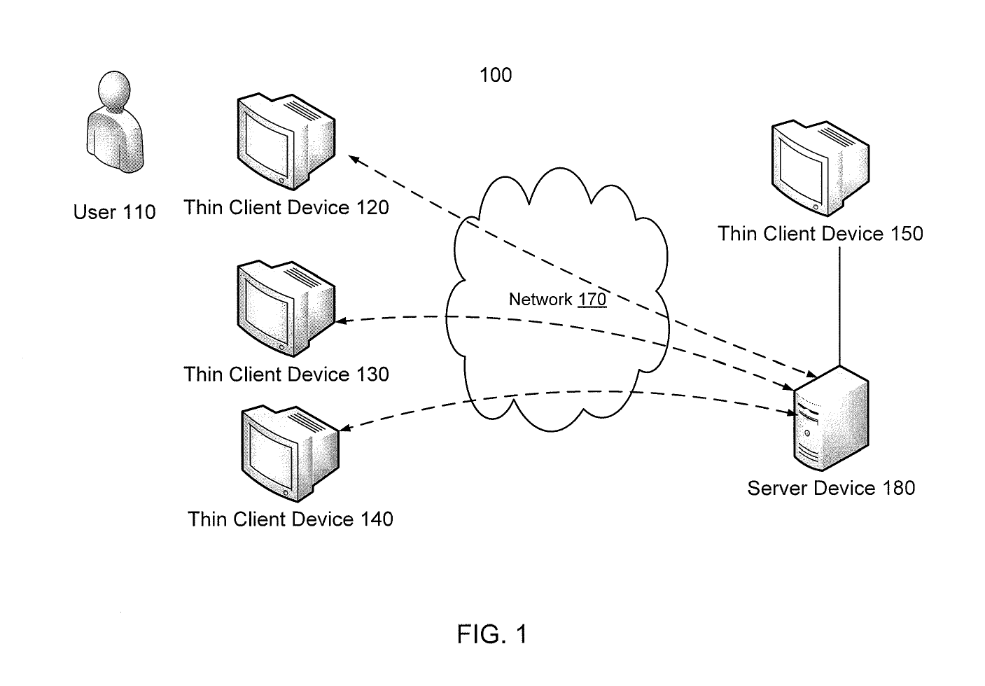

FIG. 1 is a schematic illustration of a computer system 100 including a server device 180 operatively coupled to multiple thin client devices 120, 130, 140 and 150, according to an embodiment. As shown in FIG. 1, the server device 180 is operatively coupled to the thin client devices 120, 130 and 140 through a network 170. The server device 180 is also physically connected to the thin client device 150. Each thin client device 120-150 can be accessed and operated by, for example, a user (e.g., user 110 as shown in FIG. 1).

The server device 180 can be any device that is capable of connecting to, and controlling and/or facilitating the operations (e.g., booting) of one or more thin client devices (e.g., the thin client device 120-150). The server device 180 can be configured to provide various services (e.g., a computing service, a communication service, a processing service, etc.) and process requested operations received from a thin client device operatively coupled to the server device 180. The server device 180 can be, for example, a computer server, a desktop computer, a laptop computer, a personal digital assistant (PDA), or the like. In some embodiments, the server device 180 can be a physical or virtual server that hosts one or more virtual machines providing virtual desktops for the thin client devices (e.g., the thin client device 120-150). In some embodiments, the server device 180 can be a physical server including, for example, CPU, memory, storage, and networking capacity.

In some embodiments, the server device 180 can host or include multiple thin client operating system images that can be provided to thin client devices that are operatively coupled to the server device 180. A thin client operating system image can be a file or file-system that contains a thin client operating system, executable programs, and/or any additional data files related to the thin client operating system and executable programs. In some embodiments, after such a thin client operating system image is transferred to a thin client device, the thin client operating system and/or the executable programs contained in the thin client operating system image can be loaded from the thin client operating system image to, for example, a memory or storage of the thin client device, such that the thin client operating system and/or the executable programs can be installed, run, or executed at the thin client device. In some embodiments, the server device 180 can include network file systems and remote desktop service. In some embodiments, the network file systems and/or the remote desktop service can be included in a thin client operating system image. In some embodiments, the server device 180 can include or provide, for example, a DHCP server, a PXE server, a TFTP service, and/or the like. In such embodiments, the server device 180 can be configured to, among other functionalities, manage an IP pool reserved to the client systems, provide PXE discovery services, provide a TFTP service to download configuration or boot files to a thin client device, etc.

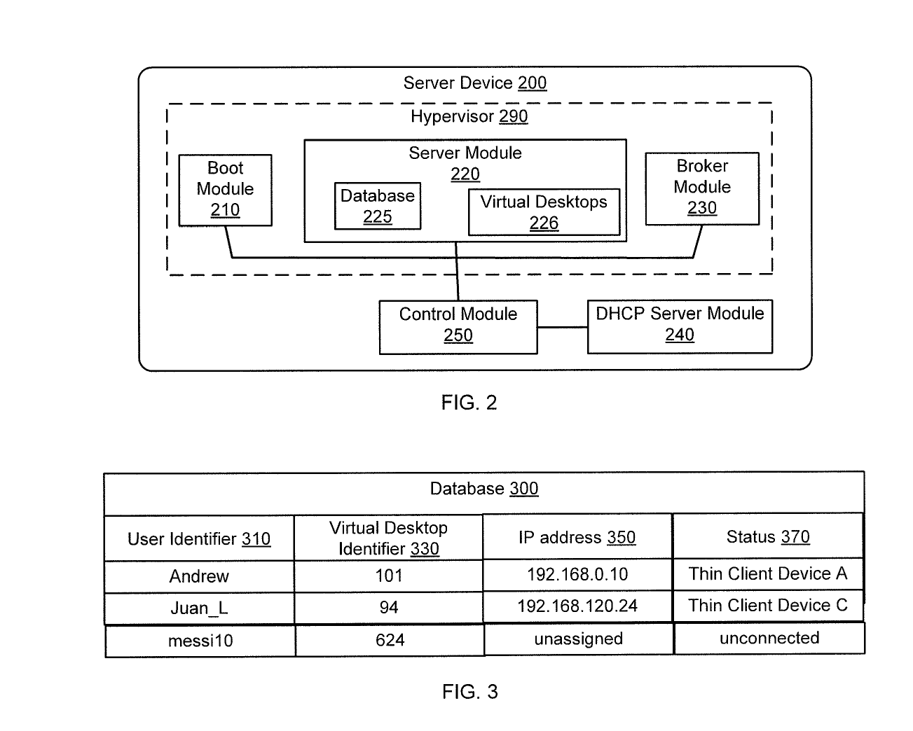

The server device 180 can include one or more hardware-based and/or software-based modules (executing in hardware and/or stored in memory) that are capable of performing various functions associated with a thin client device. Such functions can include, for example, booting the thin client device, assigning and sending an IP address to the thin client device, running a virtual desktop associated with the thin client device, executing virtual desktop applications associated with the thin client device, etc. In some embodiments, those modules can be included within a common housing (i.e., physically reside within a single hardware device). In such embodiments, the server device 180 can be a single physical device. In other embodiments, those modules can be located at more than one separate hardware devices. In such embodiments, the server device 180 can include multiple devices that are physically separate and connected by, for example, electronic wires. The details of the inner structure of a server device are further described below with respect to FIGS. 2-3.

The thin client device 120-150 can be any computer device that can provide a user interface to a user (e.g., user 110) and use a server appliance (e.g., the server device 180) to process operations for the user. The functionalities provided to the thin client device 120-150 from the server device 180 can include, for example, data retrieving, information processing, computing, etc. Furthermore, in some embodiments, the thin client device 120-150 can be configured to solely provide the user interface (e.g., a graphical user interface (GUI)) to the user, and the remaining functionality (e.g., operating system, desktop applications) can be provided by the server device 180.

As described herein, in some embodiments, the thin client device 120-150 can be a desktop computer. In some other embodiments, the thin client device 120-150 can be, for example, any physical computer device capable of running the thin client operating system and connecting to a virtual desktop running on a server appliance (e.g., the server device 180). Such a computer device typically can include a processor, memory, a network interface, and graphical capabilities. In some embodiments, such a computer device does not include or require a hard drive or similar non-volatile, user-accessible memory or storage. The thin client device 120-150 as such a computer device can be, for example, a low-end computer terminal, laptop, thin client, ATM machine, smart phone, etc. Additionally, in some embodiments, a computer device can be converted to a thin client device without additional management controls. In such embodiments, the computer device can be booted in PXE mode, allowing new hardware to be detected automatically by the server device 180.

In some embodiments, the thin client device 120-150 can be connected to a virtual desktop running on the server device 180 that is operatively or physically coupled to the thin client device 120-150. In such embodiments, the thin client device 120-150 can be connected to the virtual desktop via, for example, remote desktop software. The thin client device 120-150 can use, access, or interact with these virtual desktops as if they were running locally on the thin client device 120-150. In some embodiments, the thin client device 120-150 can have older or heterogeneous hardware, but a user (e.g., user 110) operating the thin client device 120-150 can enjoy a fast and uniform desktop experience through the virtual desktops.

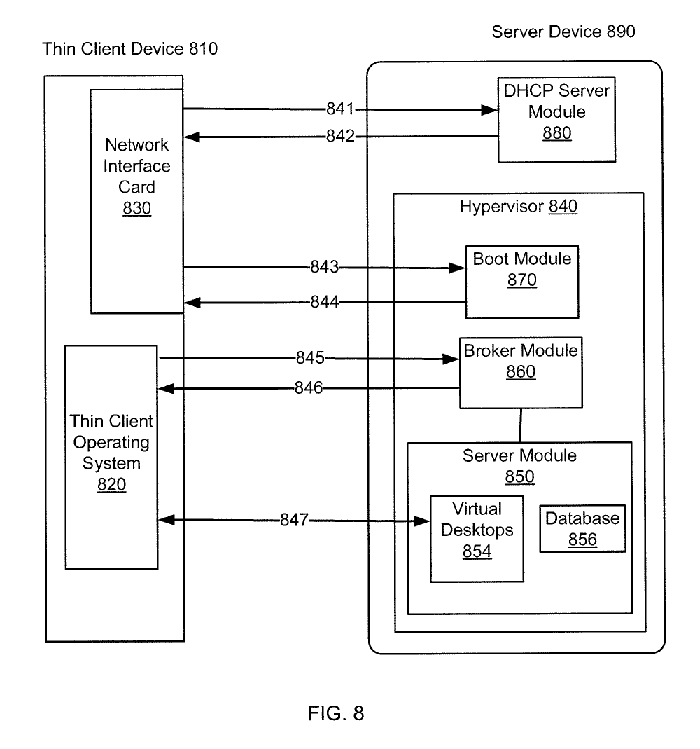

For example, the thin client devices 120-150 can be transformed from a various types of desktop computers, which can run virtual desktops residing on the server device 180. Each desktop computer (i.e., thin client device 120-150) can boot a thin client operating system that loads from the server device 180 onto, and runs entirely within, the desktop's random-access memory (RAM). The server device 180 can be configured to pair each desktop computer running the thin client operating system with a virtual desktop running on the server device 180, through the use of remote desktop software. The details of interaction between a thin client device and a server device are further described with respect to FIG. 8.

In some embodiments, each thin client device 120-150 can include an input device or component (e.g., a keyboard), a display device or component (e.g., a monitor), and a communication device or component to communicate with the server device 180 (e.g., a network interface card (NIC)). Thus, a user (e.g., user 110) can interact with a thin client device 120-150, entering data and instructions, which can then be transmitted to the server device 180. As a result, the server device 180 can be configured to process the entered instructions for each thin client device 120-150, and return the results for that particular operation to the corresponding thin client device 120-150.

In some embodiments, each thin client device 120-150 can include a memory (e.g., a volatile memory, a nonvolatile memory). In some embodiments, as described with respect to FIG. 8, the thin client device 120-150 can be configured to store a thin client operating system image received from the server device 180 in a volatile memory at the thin client device 120-150. In some embodiments, the only nonvolatile memory included in the thin client device 120-150 is a nonvolatile basic input/output system (BIOS) memory.

Furthermore, in some embodiments, the thin client device 120-150 can be configured to implement client-side features such as, for example, graphical user interface (GUI), audio input/output, digital video capturing/rendering, and the like. In such embodiments, the user's experience of using the thin client device 120-150 can be improved. In some embodiments, the communication device or component of the thin client device 120-150 can handle large amounts of data transported between the thin client device 120-150 and the server device 180.

In some embodiments, the thin client devices 120-150 do not require to be equipped with state-of-the-art or best-in-class hardware. In such embodiments, typically a substantial portion of data processing occurs on the server device 180. Thus, the thin client devices 120-150 do not need, for example, the memory, disk storage, and/or processor power provided on, for example, a typical personal computer. For example, the thin client device 120-150 can be a fifth generation x86 system (e.g., systems based on a 90 MHz Intel Pentium, with a PCI bus, a PXE-capable NIC and 32 Mbyte of RAM), which is able to provide a reasonable hardware platform to build an operating system and execute a virtual desktop on that thin client device.

The user 110 shown in FIG. 1 can be a person that uses a thin client device (e.g., the thin client device 120) to perform an operation; such a person can be, for example, a client, an operator, a network administrator, or the like. Although shown in FIG. 1 as only one user operating on a thin client device of the computer architecture 100, in other embodiments, multiple users can operate at separate thin client devices 120-150 at the same time. Similarly stated, the server device 180 can concurrently handle multiple operations requested from multiple users operating on the thin client devices 120-150. In such embodiments, each thin client device 120-150 can have its own, individual session that is connected to a virtual desktop running at the server device 180 different from other virtual desktops running at the server device 180. In such a way, each user of the multiple users can be ensured a separate work environment from peers. In some embodiments, the server device 180 can be configured to divide its time and the power of its resources among each user's session, such that requested operation from each thin client device 120-150 can be processed in a timely manner.

The network 170 can be any type of network that can operatively couple a thin client device (e.g., the thin client device 120-140) and a server device (e.g., the server device 180). The network 170 can be, for example, a wide area network (WAN), a wireless local area network (WLAN), a campus area network (CAN), the Internet, etc. In some embodiments, a thin client device (e.g., the thin client device 120-140) can communicate with the server device 180 through the network 170. In such embodiments, the routing devices within the network 170 can forward and/or switch the traffic between the thin client device and the server device 180. In some other embodiments, a thin client device (e.g., the thin client device 150) can be directly connected to the server device 180. In such embodiments, the thin client device can directly communicate with the server device 180.

FIG. 2 is a schematic illustration of the inner structure of a server device 200, according to an embodiment. The server device 200 can be structurally and functionally similar to the server device 180 shown and described with respect to FIG. 1. Furthermore, the server device 200 can be operatively coupled to one or more thin client devices (e.g., desktop computers) that are structurally and functionally similar to the thin client devices 120-150 in FIG. 1 via, for example, a network. In some embodiments, the server device 200 (including all the modules 210-250) can be implemented within a single housing. In such embodiments, the modules, virtual machines and virtual desktops included in the server device 200 can be managed and/or maintained within the housing. The management and/or maintenance can include, for example, deploying patches, applications, virus updates; enforcing desktop settings; backing up user files, etc. In other embodiments, the modules 210-250 of the server device 200 can be implemented within more than one separate housings (not shown in FIG. 2).

As shown in FIG. 2, the server device 200 includes a boot module 210, a server module 220 including a database 225 and virtual desktops 226, a broker module 230, a control module 250, and a DHCP server module 240. In some embodiments, the server device 200 can include a processor, a CPU, or the like, which is configured to execute the modules 210-250. In such embodiments, the modules 210-250 can be stored in a memory and executed by the processor. In some embodiments, each of the modules 210-250 in the server device 200 can include a field-programmable gate array (FPGA), an application specific integrated circuit (ASIC), a digital signal processor (DSP) and/or the like. Additionally, in some embodiments, some of the modules such as the boot module 210, the server module 220 and the broker module 230 can be included in and executed at a common hypervisor 290.

In some embodiments, the DHCP module 240 can be configured to run a DHCP server within the server device 200. In such embodiments, the DHCP module 240 can be responsible for responding to the DHCP request from, for example, the thin client devices operatively coupled to the service device 200. Specifically, the DHCP server module 240 can be configured to, among other operations, receive a DHCP request signal from a thin client device, assign an IP address for that thin client device, and send the assigned IP address and/or other associated information (e.g., an IP address of the boot module 210, a boot file name, etc.) to the thin client device. Alternatively, in some other embodiments, the DHCP server module 240 can be disabled if an existing DHCP server on the network can handle this functionality for the thin client devices.

In some embodiments, the boot module 210 can be configured to provide operating system files (e.g., a thin client operating system image) to a thin client device operatively coupled to the server device 200, such that a thin client operating system associated with the operating system files for the thin client device can be executed at the thin client device. Specifically, the boot module 210 can be configured to, among other operations, receive a boot request signal from a thin client device, retrieve the corresponding operating systems files from, for example, a memory or storage at the server device 200, and then send the retrieved operating system files to the thin client device. In some embodiments, such a boot request signal can be a PXE boot request signal. In some embodiments, the boot module 210 can provide a service to transfer the operating system files from the server device 200 onto a thin client device. In some embodiments, such a service can be based on the Trivial File Transfer Protocol (TFTP). Alternatively, in some other embodiments, the operating system can be loaded onto the thin client device in other suitable means, such as via local media, like CD-ROM or a hard drive.

In some embodiments, the server module 220 can be configured to store and execute one or more virtual desktops 226, each of which can be connected to a thin client device via, for example, a remote desktop connection over a network. Each of these virtual desktops 226 can include a virtual machine running an operating system, and have a means to connect with a thin client operating system running at a thin client device. The method of connection can be any remote protocol where a user can send input, such as keystrokes or mouse movement, from the thin client device to the virtual desktop, and where a user can receive output, such as display data, from the virtual desktop to the thin client device. In such a way, the thin client device can become the mechanism through which a user experiences and interacts with a virtual desktop executed at the server module 220.

In some embodiments, a virtual desktop can include one or more virtual desktop applications, such as a virtual web-browser application, a virtual telnet application, a virtual outlook application, and/or the like. Thus, by operating a thin client operating system connected to a virtual desktop, a user of a thin client device can interact with the virtual desktop applications included in that virtual desktop, which are executed at the server module 220. In such a way, the user can experience the interaction with a desktop including multiple applications as if they were running locally at the thin client device. In some embodiments, the virtual desktop applications included in a virtual desktop are uniquely associated with a user or a thin client device that is linked with that virtual desktop 226 (e.g., based on information stored in the database 225). That is, virtual desktop applications included in one virtual desktop associated with a user or a thin client device can be different from virtual applications included in another virtual desktop associated with another user or another thin client device. For example, a first user interacting with a virtual desktop associated with the first user can use a virtual Internet Explore (IE) web-browser application, while a second user interacting with another virtual desktop associated with the second user can use a virtual Firefox web-browser application.

In some embodiments, the server device 200 can include a database 225 that stores information regarding the virtual desktops 226 and their statuses. Relevant information about the virtual desktops 226 can include, for example, the name, identifier, and IP address, etc., for each virtual desktop. Relevant status information of the virtual desktops 226 can include, for example, their power state, their remote connection status, and information about the thin client devices they are connected to, etc. Furthermore, additional information and tables can be kept in the database 225.

In some embodiments, in the process of booting a thin client device, configuration settings (e.g., IP address) stored in the database 225 relating to the thin client device can be retrieved by the thin client device for use in operation with the server device 200. Alternatively, in other embodiments, such configuration settings can be maintained in and retrieved from any other effective types of data structure, such as XML data or programming objects. For example, the broker module 230 can maintain a separate programming object for each virtual desktop. This programming object can be used to maintain information regarding the virtual desktop it represents. Additionally, in some embodiments, the database 225 can be included in the server module 220, as shown in FIG. 2. In other embodiments, the database 225 can be stored in any other location within the server device 200.

FIG. 3 is a schematic illustration of a database 300 implemented within a server device, according to an embodiment. The database 300 can be similar to the database 225 shown in FIG. 2 and described above. In some embodiments, the database 300 can store information (e.g., identifier, status, etc.) associated with virtual desktops (e.g., virtual desktops 226) stored in and executed at the server device hosting the database 300.

As shown in FIG. 3, the database 300 has four columns of entries, shown as user identifier 310, virtual desktop identifier 330, IP address 350, and status 370. The first column, user identifier 310, contains user identifiers (e.g., Andrew, Juan_L, messi10), each of which uniquely identifies a user of a thin client device that is operatively coupled to the server device hosting the database 300. In some embodiments, such a user can be a person (e.g., a client, an operator, a network administrator) identified by a combination of a user ID and a password. In such embodiments, as shown in FIG. 3, the user IDs can be stored in the column of user identifier 310 as a user identifier. The second column, virtual desktop identifier 330, contains virtual desktop identifiers (e.g., 101, 94, 624), each of which uniquely identifies a virtual desktop stored in and executed at a server module (e.g., the server module 220 shown in FIG. 2) of the server device that hosts the database 300. Thus, a virtual desktop identified by such a virtual desktop identifier stored in an entry of the database 300 can be associated with a user identified by the user identifier stored in the same entry of the database 300. The third column, IP address 350, contains IP addresses (e.g., 192.168.0.10, 192.168.120.24), each of which is assigned (e.g., by a DHCP server module) to the virtual desktop that is identified by the virtual desktop identifier stored in the same entry. In some embodiments, if no IP address is currently assigned to a virtual desktop, the corresponding entry in the IP address 350 can be empty, or specified as “unassigned” as shown in the third entry of the database 300. The fourth column, status 370, contains thin client device identifiers (e.g., thin client device A, thin client device C), each of which uniquely identifies a thin client device currently connected to the corresponding virtual desktop that is identified by the virtual desktop identifier stored in the same entry. Similar to the third column, if no thin client device is currently connected to a virtual desktop, the corresponding entry in the status 370 can be empty, or specified as “unconnected” as shown in the third entry of the database 300.

In the process of booting a thin client device, after a user operating the thin client device enters a correct combination of a user ID and a password, the user can be linked to, based on the entered user ID, an entry of the database 300 that includes the user ID in the user identifier 310. As a result, a virtual desktop associated with the user can be determined based on the virtual desktop identifier stored in the virtual desktop identifier 330 of the same entry, and the thin client device identifier can be entered into the status 370 of the same entry. Furthermore, if an IP address has been assigned to the virtual desktop, that IP address can be entered into the IP address 350 of the same entry. For example, a user that enters a user ID “Andrew” and a corresponding password at a thin client device identified by “thin client device A” can be linked to the first entry stored in the database 300. As a result, the virtual desktop identified by virtual desktop identifier “101”, which is associated with the user identified by user ID “Andrew” according to the first entry of the database 300, can be determined and connected to the thin client device. The corresponding thin client device identifier, thin client device A, can be entered into the status 370 of the first entry of the database 300. Furthermore, an IP address 192.168.0.10 that is currently assigned to the virtual desktop identified by virtual desktop identifier “101” can be entered into the IP address 350 of the first entry of the database 300.

In some embodiments, if a virtual desktop is not currently being executed and connected to any thin client device, then the status 370 of the entry for that virtual desktop can be empty or specified as “unconnected.” Similarly, if no IP address is currently assigned to a virtual desktop, the IP address 350 of the entry for that virtual desktop can be empty or specified as “unassigned.” The third entry of the database 300 presents such an example.

Although shown in FIG. 3 as a virtual desktop being uniquely associated with a user of a thin client device, in some other embodiments, a virtual desktop can be uniquely associated with any other factor that can identify a booting procedure at a thin client device. Such a factor can be, for example, the thin client device that is undergoing the booting procedure. In such an example, the database 300 does not store information regarding the user that operates the thin client device (i.e., the column of user identifier 310). Instead, a thin client device can be associated with a virtual desktop in an entry of the database 300 based on, for example, the media access control (MAC) address of the thin client device. As such, the database 300 can have a column (not shown in FIG. 3) to store MAC addresses of thin client devices, each of which can be used to associate a thin client device with a virtual desktop.

Returning to FIG. 2, the broker module 230 can be configured to perform brokering operations. Brokering operations are the handling of the requests of the thin client devices and virtual desktops. Specifically, when a thin client device requests from the broker module 230 a virtual desktop to connect to, the broker module 230 can be configured to contact the database 225 within the server module 220 and return the appropriate information of the corresponding virtual desktop to the thin client device. Furthermore, the broker module 230 can be configured to initiate a communication session between the thin client operating system executing at the thin client device and the corresponding virtual desktop running at the server module 220. When the thin client device disconnects from the virtual desktop, it informs the broker module 230, which then can be configured to pass the relevant information to the database 225. In some embodiments, a thin client device can make a request to the broker module 230 by sending a virtual desktop request signal to the broker module 230. In some embodiments, such a virtual desktop request signal can include an identifier of the virtual desktop associated with the thin client device or the user operating the thin client device, or a user identifier of the user operating the thin client device.

The control module 250 can be configured to run software (executing in hardware and/or stored in memory) that is necessary for monitoring and controlling one or more of the other modules. Particularly, in some embodiments, the control module 250 can be configured to manage at least one of the boot module 210, the server module 220, or the broker module 230. Furthermore, in some embodiments, the control module 250 can be configured to manage any other module, such as the DHCP server module 240. The task of monitoring and controlling other modules can include, for example, ensuring that the proper services are running, starting, stopping, or restarting those modules that malfunction, and carrying out operations for the other modules.

In some embodiments, the control module 250 can be configured to provide a user interface (UI) to an administrator of the server device 200 such that the administrator can manage one or more of the modules within the server device 200 using the UI. For example, the UI provided by the control module 250 can be used to manage at least one of the server module 220, the boot module 210, or the broker module 230. In some embodiments, the UI provided by the control module 250 can be used to manage any other module, such as the DHCP server module 240. In some embodiments, such a UI can be part of, for example, a webpage, an application, or a thin client operating system run at a thin client device operated by the user. In some embodiments, the administrator can access the UI by a device physically or operatively coupled to the server device 200, such as a thin client device.

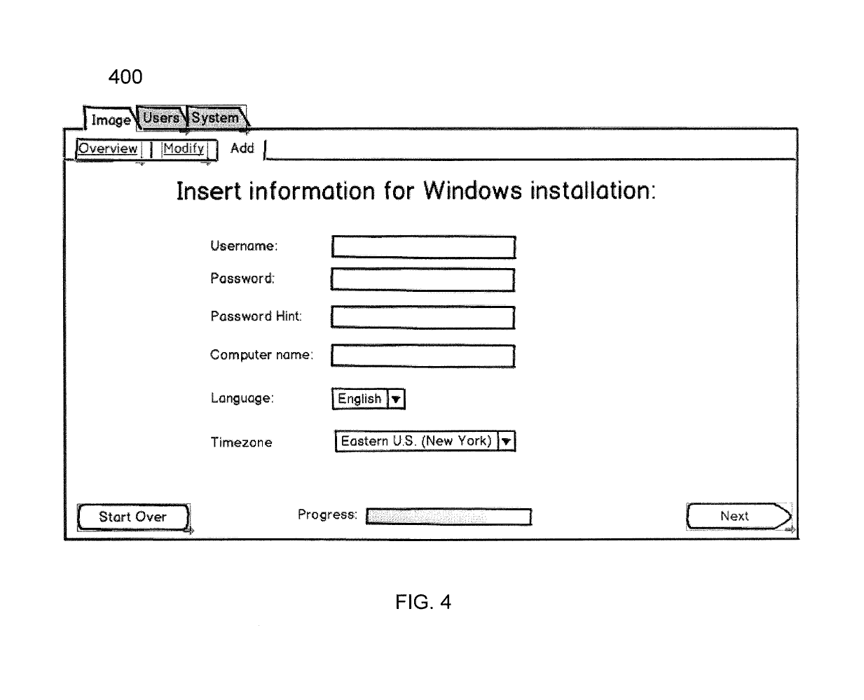

In some embodiments, the UI provided by the control module 250 can be used to manage thin client operating system images that are associated with users and/or thin client devices. FIGS. 4-7 are schematic illustrations of such a UI, according to an embodiment. Although the examples of UI included in FIGS. 4-7 are in the form of a webpage as an interface presented to an administrator, a UI provided by the control module 250 can be in any other suitable form. Furthermore, although not included in FIGS. 4-7 and not described herein, other examples of UI can also be provided to an administrator by the control module 250.

Initially, an administrator of the server device 200 can connect to an initial page of the UI, and access the UI by identifying his/her identity. For example, the administrator can log into the UI using a username and password. After successfully logging into the UI, the administrator can manage thin client operating system images for potential users of the thin client devices operatively coupled to the server device 200. In some embodiments, the administrator can add a thin client operating system image for a user and/or a thin client device using an add-page of the UI (e.g., page 400 of the UI shown in FIG. 4). Specifically, as shown in FIG. 4, the administrator can be prompted to enter a username and a password of the user, a computer name for the thin client device, and select a language and a timezone for the newly-installed thin client operating system image. Furthermore, the administrator can be prompted to, for example, select an operating system for the newly-installed thin client operating system image, upload images used in the thin client operating system image, etc. The information and data entered by the administrator can then be stored within the server device 200 (e.g., in the server module 220), and the newly-installed thin client operating system image can be associated with one or more virtual desktops 226 maintained in the server module 220.

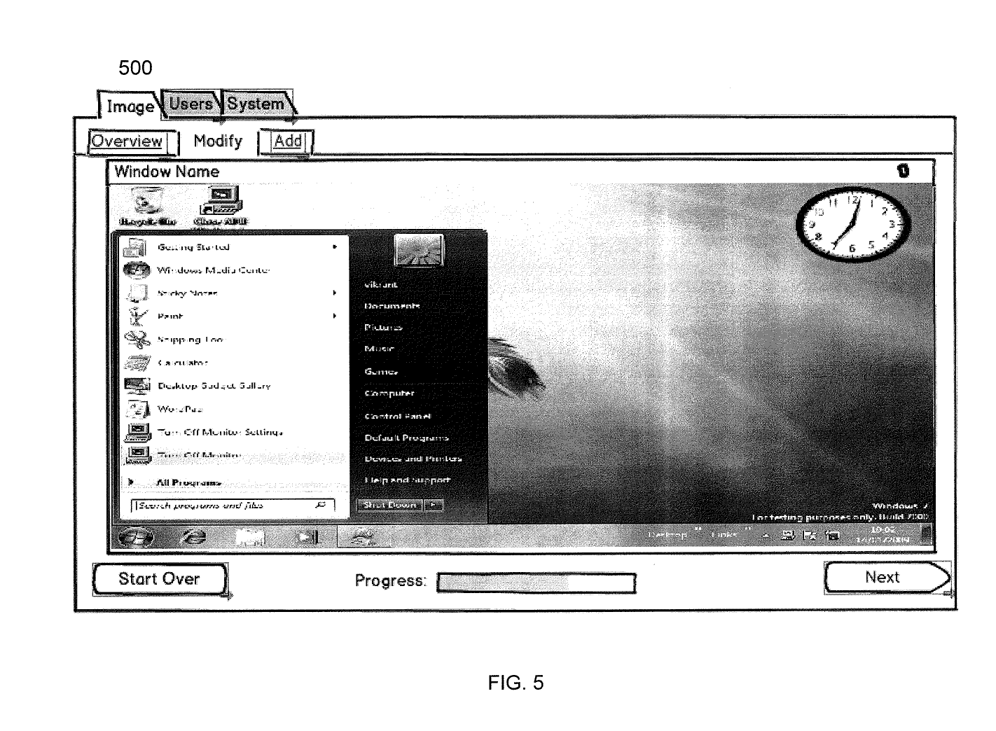

In some embodiments, the administrator can modify a previously-installed thin client operating system image using a modify-page of the UI (e.g., page 500 of the UI shown in FIG. 5). Specifically, the administrator can, for example, run updates on a thin client operating system image, add or remove software to a thin client operating system image, edit or replace a thin client operating system image, change the association of a thin client operating system image with a virtual desktop, etc. For example, the administrator can edit the thin client operating system image presented in UI 500 shown in FIG. 5. After the modification on the thin client operating system image is done, the modified thin client operating system image can be saved.

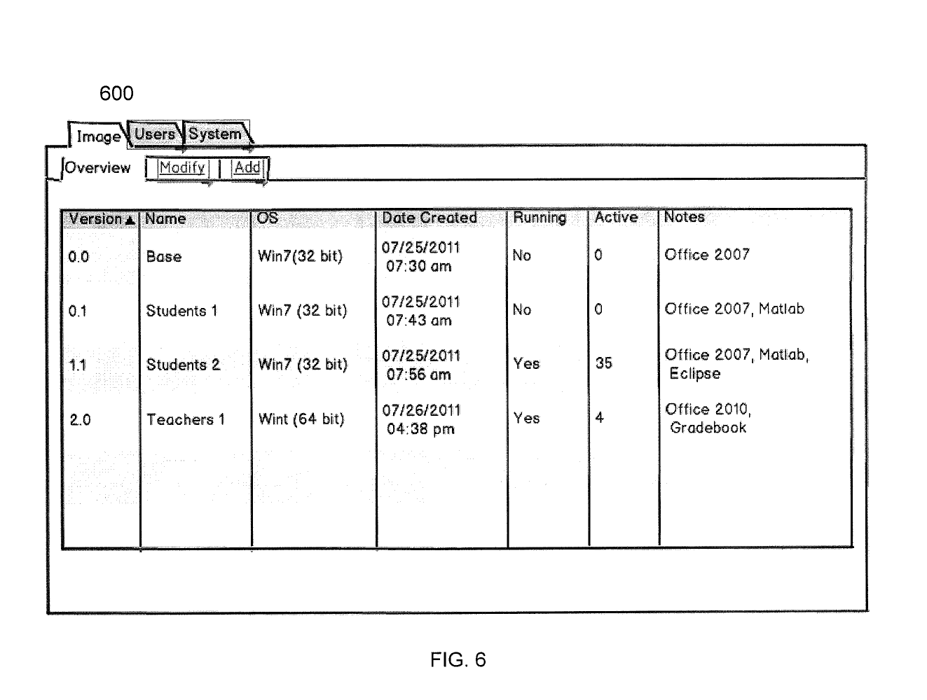

In some embodiments, the administrator can view an overview of the thin client operating system images associated with virtual desktops 226 using a image-overview-page of the UI (e.g., page 600 of the UI shown in FIG. 6). As shown in FIG. 6, the overview of the thin client operating system images can be presented in a table. Each entry (i.e., row) of the table is associated with a thin client operating system image. Specifically, information of a thin client operating system image presented in an entry of the table can include, for example, a version of the image (e.g., 0.0), a name of the image (e.g., base), an operating system associated with the image (e.g., win7(32 bit)), a date when the image is created (e.g., Jul. 25, 2011 07:30 am), whether the virtual desktop associated with the image is currently running (e.g., yes or no), the number of active thin client operating systems that are currently connected to the virtual desktop (e.g., 0), the software installed on the image (e.g., Office 2007), etc. Note that as shown in FIG. 6, the virtual desktop associated with the image not being currently running indicates that the number of active thin client operating systems currently connected to that virtual desktop is 0. On the other hand, more than one active thin client operating systems can be currently connected to a virtual desktop that is currently running. Additionally, it should be understood that the items shown in the table of FIG. 6 do not necessarily represent a complete list of items associated with a given thin client operating system image that can be presented to the administrator. In some other embodiments, more or less items associated with a given thin client operating system image can be presented in the image-overview-page of the UI.

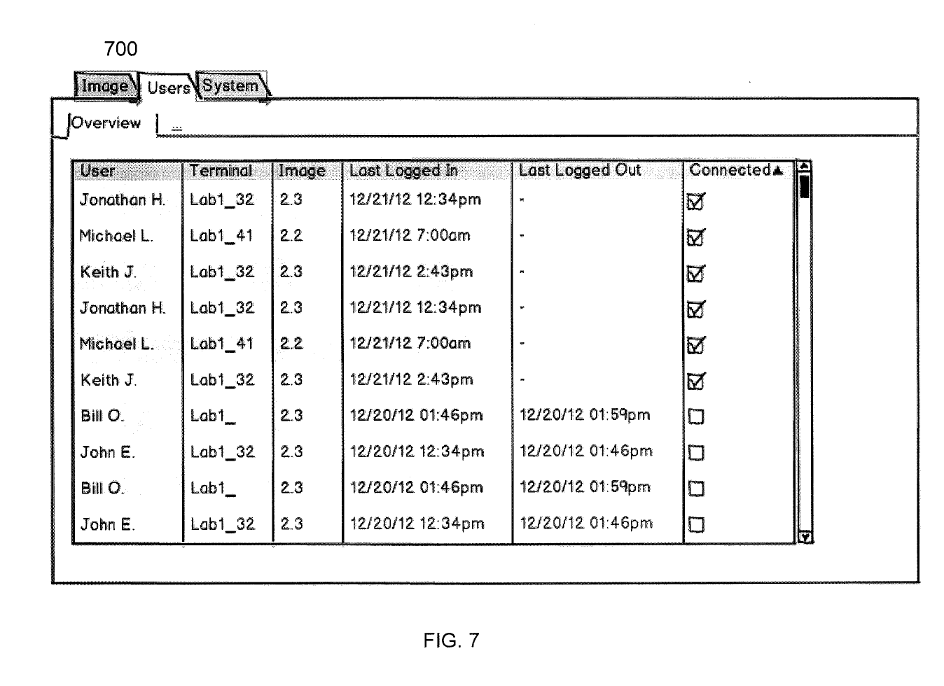

In some embodiments, the administrator can view an overview of the users of the thin client devices using a user-overview-page of the UI (e.g., page 700 of the UI shown in FIG. 7). As shown in FIG. 7, the overview of the users can be presented in a table similar to the table shown in FIG. 6. Each entry (i.e., row) of the table is associated with a record of a user session associated with a user. Specifically, information of a user session presented in an entry of the table can include, for example, a name of the user (e.g., Bill O.), a thin client device used by the user in the user session (e.g., Lab1_), an identifier of the thin client operating system image used in the user session (e.g., 2.3), a log-in time for the user session (e.g., Dec. 20, 2012 01:46 pm), a log-out time for the user session (e.g., Dec. 20, 2012 01:59 pm), whether the user is currently connected (e.g., yes or no), etc. Note that as shown in FIG. 7, a user that is currently connected indicates a live user session, which does not have a log-out time yet. Furthermore, as discussed herein, a thin client operating system image can be associated with a user of a thin client device, or alternatively, a thin client device itself. Additionally, it should be understood that the fields shown in the table of FIG. 7 does not necessarily represent a complete list of fields associated with an overview of a user or a user session presented to the administrator. In some other embodiments, more or less fields associated with a user or a user session can be presented in the user-overview-page of the UI.

Furthermore, although not shown in FIGS. 4-7 and described herein, the UI provided by the control module 250 can be configured to present other information or facilitate other operations for the administrator. For example, the UI can be configured to present a status overview (e.g., running time, last shutdown status, connected clients, etc.) of the server device 200. For another example, the UI can be configured to control the operation (e.g., shut down) of a virtual desktop associated with a thin client operating system, and/or manage the connection (e.g., disconnect) between a virtual desktop and a thin client operating system image.

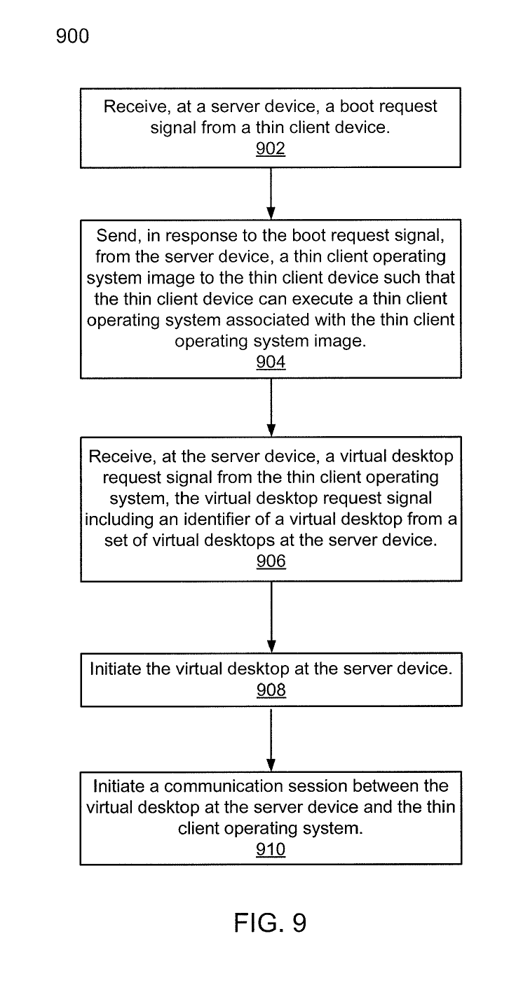

Returning to FIG. 2, each of the modules 210-250 can be (operatively) coupled to each of the remaining modules 210-250. In some embodiments, all or a subset of the modules 210-250 can be configured to collectively interact with one or more thin client devices that are operatively coupled to the server device 200. As a result, all or a subset of the modules 210-250 within the server device 200 can enable booting the thin client devices and executing a virtual desktop that is associated with each of the thin client devices. Details of the functionalities of the modules 210-250 and their interaction with the thin client devices are further described with respect to FIGS. 8-9.

In some embodiments, some of the modules 210-250 or other virtual machines can be included within and executed at a common hypervisor. For example, as shown in FIG. 2, the boot module 210, the server module 220 and the broker module 230 can be included in and executed at a hypervisor 290. In some embodiments, the modules 210-250 and other virtual machines (not shown in FIG. 2) can be joined to share one or more hypervisors (e.g., hypervisor 290) in any given combination. For example, although shown in FIG. 2 as the DHCP server module 240 not included in the hypervisor 290, in other embodiments, the DHCP server module 240 can be included in the hypervisor 290. Additionally, any one of these modules or other server components can run on the server device 200 as a service alongside the hypervisor 290. In some embodiments, one module can carry out the services provided from multiple modules shown in FIG. 2 and described herein. For example, the control module 250 can include programming objects representing the virtual desktops. Thus, the control module 250 can fulfill the function of the server module 220.

The hypervisor 290 can enable multiple instances of a variety of operating systems (e.g., multiple thin client operating systems) to share the common virtualized hardware resources provided from the hypervisor 290 and thus, run concurrently. In this sense, the hypervisor 290 can present to multiple thin client operating systems a virtual operating platform and manage the execution of the multiple thin client operating systems. In some embodiments, a hypervisor can be referred to as a virtual machine manager (VMM). In some embodiments, as an alternative to the hypervisor, non-hypervisor virtualization systems can be used for similar tasks on dedicated server hardware, such as a server device, a desktop, a portable and even handheld computer, and/or the like.

In some embodiments, not all of the modules 210-250 are present to achieve the goal of using, for example, physical desktop computers, as thin client devices to connect with virtual desktops executed at the server device 200. In some embodiments, if the preexisting network already has servers for particular functions or if certain features are not needed (e.g., DHCP service), then the corresponding module (e.g., the DHCP server module 240) is not included in the service device 200.

FIG. 8 is a schematic illustration of interaction between a thin client device 810 and a server device 890, according to an embodiment. Specifically, FIG. 8 illustrates steps of the boot process of the thin client device 810 using the server device 890. The thin client device 810 can be physically connected or operatively coupled to the server device 890. The thin client device 810 can be structurally and functionally similar to the thin client device 120-150 shown and described with respect to FIG. 1. As shown in FIG. 8, the thin client device 810 can include a NIC 830, through which the thin client device 810 can communicate with the server device 890 or any other device that is operatively coupled to the NIC 830 of the thin client device 810 via, for example, a network (e.g., the network 170 shown and described with respect to FIG. 1).

The thin client device 810 can include and execute a thin client operating system 820, which can be configured to interact with a virtual desktop at the server device 890 in a communication session. In some embodiments, the thin client operating system 820 can be maintained within the thin client device 810, and a thin client operating system image associated with the thin client operating system 820 can be maintained at the server device 890. In such embodiments, during a boot process for the thin client device 810, the thin client operating system image can be transferred from the server device 890 to the thin client device 810. As a result, the thin client operating system 820 can be installed at the thin client device 810. In some other embodiments, alternatively, the thin client operating system 820 can be included in a thin client operating system image maintained at the server device 890. In such embodiments, during the boot process for the thin client device 810, the thin client operating system image can be transferred from the server device 890 to the thin client device 810. As a result, the thin client operating system 820 can be loaded from that thin client operating system image to the thin client device 810, such that the thin client operating system 820 can be installed at the thin client device 810.

The server device 890 can be structurally and functionally similar to the server device 180 and the server device 200 shown and described with respect to FIG. 1 and FIG. 2, respectively. As shown in FIG. 8, the server device 890 can include a DHCP server module 880, a boot module 870, a broker module 860, and a server module 850 including virtual desktops 854 and a database 856. The modules included in the server device 890 can be structurally and functionally similar to the corresponding modules shown and described with respect to FIG. 2 (i.e., the DHCP server module 240, the boot module 210, the broker module 230, the server module 220 including the virtual desktops 226 and the database 225), respectively. Furthermore, the boot module 870, the broker module 860 and the server module 850 can be included in and executed at a common hypervisor 840, which can be similar to the hypervisor 290 of the server device 200 shown and described with respect to FIG. 2. Additionally, although not shown in FIG. 8, the server device 890 can include one or more other modules that can facilitate or be involved in the boot process of the thin client device 810. For example, the server device 890 can include a control module similar to the control module 250 shown and described with respect to FIG. 2, which can be configured to manage at least one of the boot module 870, the broker module 860 or the server module 850, and control the boot process of the thin client device 810.

In some embodiments, as an initial step of the boot process of the thin client device 810, the thin client device 810 can be powered on by, for example, a user of the thin client device 810. In some embodiments, the BIOS of the thin client device 810 can be set to allow the thin client device 810 to perform a network boot with its NIC 830 set as the primary boot device. In such embodiments, the thin client device 810 relies on a device coupled to the NIC 830 of the thin client device 810 to facilitate the boot process. Specifically, the thin client device 810 can be configured to broadcast a DHCP request signal, which requests for an IP address for the thin client device 810, from the NIC 830. The DHCP request signal can be broadcast to all or a portion of the network devices (e.g., a computer, a server, a router, a peripheral processing device, etc.) physically or operatively coupled to the thin client device 810 via the NIC 830 of the thin client device 810. Particularly, as shown by the signal 841 in FIG. 8, the DHCP request signal can be sent to the server device 890 that is physically connected or operatively coupled to the thin client device 810.

In response to receiving the DHCP request signal 841 from the thin client device 810, the DHCP server module 880 that resides on the server device 890 can be configured to respond to the DHCP request signal 841. Specifically, the DHCP server module 880 can be configured to assign an IP address for the thin client device 810 from, for example, a reserved pool of IP addresses associated with the DHCP server module 880, and then send the assigned IP address to the NIC 830 of the thin client device 810, shown as the signal 842 in FIG. 8. In some embodiments, the IP addresses included in the reserved pool of IP addresses are reserved for thin client devices interacting with the server device 890, such as the thin client device 810, and are assigned and sent to a thin client device in response to receiving a DHCP request signal from that thin client device, as described above.

In some embodiments, the DHCP server module 880 can be configured to send an IP address of the boot module 870 within the server device 890 as well as a boot filename and/or other information, together with the IP address assigned to the thin client device 810, to the NIC 830 of the thin client device 810. The boot filename sent to the thin client device 810 can be used to locate a thin client operating system image that is associated with the thin client operating system 820 of the thin client device 810 and stored within the server device 890. In some embodiments, multiple thin client operating system images can be stored within the server device 890, where each of the thin client operating system images is associated with one or more thin client operating systems executed at one or more thin client devices. The server device 890 can have a mechanism (e.g., a database, a table) to associate each of the thin client operating system images with its corresponding thin client device(s). Thus, the server device 890 can be configured to determine a boot filename for a thin client operating system image based on a DHCP request signal 841 received from a thin client device associated with that thin client operating system image.

After the thin client device 810 receives, from the server device 890, the IP address assigned to the thin client device 810, the IP address of the boot module 870, the boot filename for the appropriate thin client operating system image, and/or other related information, the thin client device 810 can be configured to send a boot request signal from its NIC 830 to the boot module 870 of the server device 890, shown as the signal 843 in FIG. 8. The boot request signal 843 can include the IP address of the thin client device 810 as, for example, a source IP address, the IP address of the boot module 870 as, for example, a destination IP address. The boot request signal 843 can also include the boot filename for the appropriate thin client operating system image, such that the boot module 870 can be configured to locate that thin client operating system image based on the boot request signal 843. In some embodiments, the boot request signal 843 can be a PXE boot request signal. In such embodiments, the boot request signal 843 and subsequent signals or messages exchanged between the thin client device 810 and the server device 890 are compliant with the PXE network boot protocol.

In response to receiving a boot request signal from the thin client device 810, the boot module 870 can be configured to retrieve a thin client operating system image based on the received boot request signal 843, and then send the thin client operating system image to the thin client device 810, represented by the signal 844 in FIG. 8. As discussed above, the boot request signal 843 can include a boot filename for the corresponding thin client operating system image associated with the thin client operating system 820 of the thin client device 810. Based on the boot filename, the boot module 870 can be configured to locate the thin client operating system image from, for example, a storage (not shown in FIG. 8, e.g., a database, a memory) within the server device 890, where thin client operating system images are stored. In some embodiments, the thin client operating system image sent from the boot module 870 to the thin client device 810 (via signal 844) can be a copy of the thin client operating system image stored within the server device 890.

In some embodiments, the boot module 870 can be configured to send the thin client operating system image to the thin client device 810 via signal 844 using TFTP. In such embodiments, the NIC 830 of the thin client device 810 is capable of transferring and receiving files via TFTP. Alternatively, the boot module 870 can be configured to send the thin client operating system image to the thin client device 870 via signal 844 using other suitable transfer protocol, such as multicast TFTP (MTFTP), FTP, etc. In some embodiments, PXE and TFTP can be used to load a thin client environment (e.g., a thin client operating system image) from a server device (e.g., the server device 890) to a remotely-coupled thin client device (e.g., the thin client device 810). In such embodiments, the thin client device does not use any kind of local fixed mass-storage device. Thus, the thin client device can be, for example, a diskless GUI-based thin client device. In some embodiments, such a thin client device has as its only nonvolatile memory a nonvolatile BIOS memory (i.e., no flash memory, hard disk, floppy disk, and/or the like). In other embodiments, a thin client device can boot via other suitable means that does not use a remote transfer of files, such as CD ROM, USB-connected device, floppy or hard disk, and/or the like.

In some embodiments, after receiving the thin client operating system image, the thin client device 810 can be configured to store the received thin client operating system image in a memory (not shown in FIG. 8) within the thin client device 810. In some embodiments, such a memory can be a volatile memory (e.g., a RAM). As a result of receiving the thin client operating system image associated with the thin client operating system 820, the thin client device 810 can be configured to execute the thin client operating system 820. That is, the thin client device 810 can be configured to boot the thin client operating system 820 using the thin client operating system image received from the boot module 870.

In some embodiments, a virtual desktop is used during the boot process of the thin client operating system 820 within the thin client device 810. In such embodiments, the thin client operating system 820 can be configured to send a virtual desktop request signal to the broker module 860 of the server device 890, shown as the signal 845 in FIG. 8. In some embodiments, the virtual desktop request signal 845 sent from the thin client operating system 820 to the broker module 860 can include an identifier of a virtual desktop, which can be used to uniquely determine the virtual desktop from the set of virtual desktops 854 stored and maintained at the server module 850. For example, the identifier of the virtual desktop can be similar to the virtual desktop identifiers stored in the column of virtual desktop identifier 330 in the database 300 shown and described with respect to FIG. 3. Thus, in such embodiments, the broker module 860 can be configured to determine the virtual desktop requested by the thin client operating system 820 based on the identifier of the virtual desktop included in the virtual desktop request signal 845.

In some embodiments, the broker module 860 can be configured to determine the virtual desktop requested by the thin client operating system 820 by querying the database 856 within the server module 850 based on information provided in the virtual desktop request signal 845 (e.g. the user of the thin client device 810). In such embodiments, the database 856 can be similar to the database 300 shown and described with respect to FIG. 3, which associates a virtual desktop with information provided in the virtual desktop request signal, such as a user of the thin client device 810, and records other information (e.g., IP address, status) of the virtual desktop. For example, if the database 856 has the same entries as the database 300 shown in FIG. 3, and the virtual desktop request signal indicates that the user of the thin client device has a user name “messi10”, then the broker module 860 can determine that the identifier of the virtual desktop requested by the thin client operating system 820 is “624” according to the third entry of the database 300.

After a virtual desktop requested by the thin client operating system 820 is determined, the broker module 860 can be configured to initiate a communication session between the virtual desktop running at the server module 850 and the thin client operating system 820 executing at the thin client device 810. In some embodiments, if the virtual desktop is inactive and not currently assigned an IP address, the broker module 860 can be configured to interact with the DHCP server module 880, such that the DHCP server module can assign an IP address to the virtual desktop. In some embodiments, the assigned IP address can be stored in an entry for the virtual desktop in the database 856.

In some embodiments, the broker module 860 can be configured to retrieve information of the requested virtual desktop, and then send the retrieved information to the thin client operating system 820, represented by the signal 846 in FIG. 8. In some embodiments, the information of the requested virtual desktop can be retrieved from, for example, the database 856. Such information can include, for example, the IP address of the requested virtual desktop, the identifier of the requested virtual desktop. In some embodiments, the broker module 860 can be configured to send other information related to the requested virtual desktop, which can be used in establishing the communication session between the virtual desktop and the thin client operating system 820. In some embodiments, other than retrieving the information of the requested virtual desktop and sending the retrieved information to the thin client operating system 820 via signal 846, the broker module 860 can be configured to initiate the requested virtual desktop, such that the requested virtual desktop can be initialized to run at the server module 850 and made ready for communicating with the thin client operating system 820. For example, the broker module 860 can be configured to provide the IP address of the thin client device 810 to the requested virtual desktop.

After the thin client operating system 820 receives the information of the requested virtual desktop via signal 846 provided from the broker module 860, a communication session between the thin client operating system 820 and the corresponding virtual desktop can be established, represented by signals 847 in FIG. 8. For example, the thin client operating system 820 can initiate the communicate session by sending an initialization signal 847 to the virtual desktop (e.g., destined to the IP address of the virtual desktop). In response to receiving such an initialization signal 847, the virtual desktop can reply an acknowledgement signal 847 to the thin client operating system 820. Alternatively, the communication session between the thin client operating system 820 and the virtual desktop can be established in any other suitable manner. In some embodiments, such a communication session can be established via a suitable protocol, such as virtual network computing (VNC) protocol, remote desktop protocol (RDP), etc. As a result of such a communication session being established, the virtual desktop (including various virtual desktop applications) running at the server module 850 of the server device 890 can be presented to the user of the thin client device 810 as if the user were interacting with the virtual desktop (including the various applications) executing locally at the thin client device 810.

In some embodiments, after the communication session 847 is established between the thin client operating system 820 and the virtual desktop executing at the server module 850, information associated with the communication session can be stored into the database 856. For example, as shown and described with respect to FIG. 3, the thin client device 810 can be entered into the status column of the entry for the virtual desktop in the database 856.

In some embodiments, after the communication session 847 is established between the thin client operating system 820 and the virtual desktop executing at the server module 850, the thin client operating system 820 can be configured to send a set of commands to the server module 850 via the communication session 847. In response, the server module 850 can be configured to operate according to the received commands, and also send a set of commands (via signals 847) to the thin client operating system 820, which are to be executed by the thin client operating system 820. In some embodiments, the commands exchanged between the thin client operating system 820 and the server module 850 can be related to, for example, maintaining the communication session 847, presenting the virtual desktop in a display of the thin client device 810, executing a virtual desktop application, soliciting input from the user of the thin client device 810, or the like.

In some embodiments, when the communication session 847 is disconnected or over (e.g., the user logs off the thin client device 810, the thin client device 810 is powered off, etc.), the thin client operating system 820 and/or the virtual desktop can be shut down or terminated executing, and the status of the virtual desktop can be updated accordingly in the database 856.

FIG. 9 is a flow chart that illustrates a method for booting a thin client device through a server device, according to an embodiment. In some embodiments, a server device in a computer architecture (e.g., the server device 180 in the computer architecture 100 as shown in FIG. 1) can have a non-transitory processor-readable medium that stores code representing instructions to be executed by a processor within that server device. The code can include code to cause the processor within the server device to perform, among other operations, a series of operations as described below.

At 902, a boot request signal can be received at the server device from the thin client device. In some embodiments, the thin client device can be configured to send the boot request signal to the server device after the thin client device sends a DHCP request signal to the server device and receives a response signal (e.g., including an IP address assigned to the thin client device, an IP address of a boot module of the server device, a boot filename, etc.) in response to the DHCP request signal. The boot module of the server device can be configured to receive the boot request signal from a NIC of the thin client device. In some embodiments, the boot request signal can include, for example, the IP address assigned to the thin client device, the IP address of the boot module of the server device, and the boot filename for a thin client operating system image associated with a thin client operating system executing at the thin client device. In some embodiments, the boot request signal can be a PXE boot request signal.

In the example of FIG. 8, a boot request signal 843 can be received at the boot module 870 of the server device 890 from the NIC 830 of the thin client device 810. The boot request signal 843 can include an IP address assigned to the thin client device 810 (e.g., assigned by the DHCP server module 880 prior to the boot module 870 receiving the boot request signal) as a source IP address, an IP address of the boot module 870 as a destination IP address, and a boot filename for a thin client operating system image associated with the thin client operating system 820 executing at the thin client device 810.

At 904, in response to the boot request signal, the thin client operating system image can be sent from the server device to the thin client device. As a result, the thin client device can execute the thin client operating system associated with the thin client operating system image. In some embodiments, the appropriate thin client operating system image can be determined by the boot module of the server device based on, for example, the boot filename included in the boot request signal. The boot module can be configured to retrieve the thin client operating system image (or a copy of the thin client operating system image) from, for example, a storage (e.g., a memory) within the server device that stores thin client operating system images. Subsequently, the boot module can be configured to send the retrieved thin client operating system image to the thin client device. In some embodiments, the thin client operating system image can be sent to the thin client device via TFTP. Furthermore, in response to receiving such a thin client operating system image, the thin client device can be configured to boot the thin client operating system associated with the received thin client operating system image.

In the example of FIG. 8, in response to the boot request signal 843 received at the boot module 870, the boot module 870 can be configured to retrieve a thin client operating system image associated with the thin client operating system 820 based on the boot filename included in the boot request signal. The boot module 870 can then be configured to send the thin client operating system image (via signal 844) to the thin client device 810 via the NIC 830. As a result, the thin client device 810 can be configured to boot the thin client operating system 820 using the thin client operating system image of signal 844 received from the boot module 870.

At 906, a virtual desktop request signal can be received at the server device from the thin client operating system. In some embodiments, the virtual desktop request signal can be received at a broker module of the server device from the thin client operating system executing at the thin client device. The virtual desktop request signal can include an identifier of a requested virtual desktop from a set of virtual desktops at the server device, where the requested virtual desktop can be associated with the thin client operating system. Thus, the broker module can be configured to determine the requested virtual desktop based on the identifier of that virtual desktop. Subsequently, at 908, the virtual desktop can be initiated at the server device in response to the server device receiving such a virtual desktop request signal.

In the example of FIG. 8, a virtual desktop request signal 845 can be received at the broker module 860 of the server device 890 from the thin client operating system 820 executing at the thin client device 810. The virtual desktop request signal 845 can include an identifier of a requested virtual desktop from the set of virtual desktops 854 stored and maintained at the server module 850 of the server device 890. Based on such a virtual desktop identifier, the broker module 860 can be configured to determine the requested virtual desktop from the set of virtual desktops 854. Subsequently, the broker module 860 can be configured to initiate the requested virtual desktop, and make the virtual desktop ready for communicating with the thin client operating system 820. Additionally, in some embodiments, the broker module 860 can be configured to trigger the DHCP server module 880 to assign an IP address to the requested virtual desktop.

At 910, a communication session between the virtual desktop at the server device and the thin client operating system can be initiated. Specifically, the broker module of the server device can be configured to retrieve information of the requested virtual desktop (e.g., from a database within the server device), and then send the retrieved information to the thin client operating system. The information can include, for example, the IP address of the requested virtual desktop. As a result, the communication between the thin client operating system and the virtual desktop can be established. In some embodiments, such a communication session can be established via a suitable protocol, such as VNC, RDP, etc.

In the example of FIG. 8, the broker module 860 can be configured to retrieve information of the virtual desktop from the database 856, and then send the retrieved information to the thin client operating system 820, shown as the signal 846. The information of the virtual desktop can include at least the IP address of the virtual desktop, such that the thin client operating system 820 can communicate with the virtual desktop. Subsequently, a communication session can be initiated between the thin client operating system 820 and the virtual desktop executing at the server module 850, shown as the signal 847. As a result, the virtual desktop (including various virtual desktop applications) executing at the server module 850 of the server device 890 can be presented to a user of the thin client device 810 as if the user is interacting with the desktop (including the various applications) executing locally at the thin client device 810.

While various embodiments have been described above, it should be understood that they have been presented by way of example only, not limitation, and various changes in form and details may be made. Any portion of the apparatus and/or methods described herein may be combined in any combination, except mutually exclusive combinations. The embodiments described herein can include various combinations and/or sub-combinations of the functions, components and/or features of the different embodiments described. Furthermore, where methods described herein indicate certain events occurring in certain order, the ordering of certain events may be modified. Additionally, certain of the events may be performed concurrently in a parallel process when possible, as well as performed sequentially as described herein.

While shown and described above with respect to FIG. 2 as the server device 200 including the modules 210-250, in other embodiments, a server device can include any other module that can provide other services. For example, a server device can include a domain name system (DNS) server, which can provide DNS functionality to the network. Alternatively, such a DNS server can be disabled if there is an existing DNS server on the network or if the network does not need its services.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), and Read-Only Memory (ROM) and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

What is claimed is:

1. An apparatus, comprising:
a boot module within a housing, the boot module configured to receive a boot request signal from a thin client device, the boot module configured to send, in response to the boot request signal, a thin client operating system image to the thin client device such that the thin client device can execute a thin client operating system associated with the thin client operating system image;
a server module within the housing, the server module configured to execute a plurality of virtual desktops; and
a broker module within the housing, the broker module configured to receive, from the thin client operating system executing at the thin client device, a virtual desktop request signal including an identifier of a virtual desktop from the plurality of virtual desktops, the broker module configured to initiate, based on the identifier, a communication session between the virtual desktop at the server module and the thin client operating system executing at the thin client device.

2. The apparatus of claim 1, further comprising:
a Dynamic Host Configuration Protocol (DHCP) server module within the housing, the DHCP server module configured to receive a DHCP request signal from the thin client device prior to the boot module receiving the boot request signal, the DHCP server module configured to send, in response to the DHCP request signal, an Internet Protocol (IP) address associated with the thin client device and an IP address associated with the boot module to the thin client device.

3. The apparatus of claim 1, wherein the boot module, the server module and the broker module are executed at a common hypervisor within the housing.

4. The apparatus of claim 1, wherein the boot request signal is a Preboot Execution Environment (PXE) boot request signal.

5. The apparatus of claim 1, wherein the boot module is configured to send the thin client operating system image to the thin client device via Trivial File Transfer Protocol (TFTP).

6. The apparatus of claim 1, wherein the boot module is configured to send the thin client operating system image to the thin client device such that the thin client device can store the thin client operating system image in a volatile memory at the thin client device.

7. The apparatus of claim 1, further comprising:
a control module within the housing, the control module configured to manage at least one of the boot module, the server module or the broker module, the control module configured to provide a user interface (UI) to a user such that the user can manage at least one of the boot module, the server module or the broker module using the UI.

8. The apparatus of claim 1, wherein the identifier of the virtual desktop is an identifier associated with a user of the thin client device.

9. The apparatus of claim 1, wherein the boot module is configured to receive the boot request signal from the thin client device having as its only nonvolatile memory a nonvolatile basic input/output system (BIOS) memory.

10. The apparatus of claim 1, further comprising:
a control module within the housing, the control module configured to manage at least one of the boot module, the server module or the broker module, the control module configured to provide a user interface (UI) to a user such that the user can manage at least one of the boot module, the server module or the broker module using the UI, the UI being part of one of a webpage, an application, or the thin client operating system.

11. A non-transitory processor-readable medium storing code representing instructions to be executed by a processor, the code comprising code to cause the processor to:
receive, at a server device, a boot request signal from a thin client device;
send, in response to the boot request signal, from the server device, a thin client operating system image to the thin client device such that the thin client device can execute a thin client operating system associated with the thin client operating system image;
receive, at the server device, a virtual desktop request signal from the thin client operating system, the virtual desktop request signal including an identifier of a virtual desktop from a plurality of virtual desktops at the server device;
initiate the virtual desktop at the server device; and
initiate a communication session between the virtual desktop at the server device and the thin client operating system.

12. The non-transitory processor-readable medium of claim 11, further comprising code to cause the processor to:
receive, at the server device, a Dynamic Host Configuration Protocol (DHCP) request signal from the thin client device; and
send, in response to the DHCP request signal, an Internet Protocol (IP) address associated with the thin client device.

13. The non-transitory processor-readable medium of claim 11, wherein the boot request signal is a Preboot Execution Environment (PXE) boot request signal.

14. The non-transitory processor-readable medium of claim 11, wherein the code to cause the processor to send the thin client operating system image includes code to cause the processor to send the thin client operating system image to the thin client device via Trivial File Transfer Protocol (TFTP).

15. An apparatus, comprising:
a boot module executed at a hypervisor within a housing remote from a thin client device, the boot module configured to send a thin client operating system image to the thin client device such that the thin client device can execute a thin client operating system associated with the thin client operating system image; and
a server module executed at the hypervisor within the housing, the server module configured to initiate a virtual desktop in response to a virtual desktop request from the thin client operating system.

16. The apparatus of claim 15, further comprising:
a Dynamic Host Configuration Protocol (DHCP) server module executed at the hypervisor within the housing, the DHCP server module configured to receive, prior to the boot module sending the thing client operating system image, a DHCP request signal from the thin client device, the DHCP server module configured to send, in response to the DHCP request signal, an Internet Protocol (IP) address associated with the thin client device and an IP address associated with the boot module to the thin client device.

17. The apparatus of claim 15, further comprising:
a broker module executed at the hypervisor within the housing, the broker module configured to receive, from the thin client operating system executing at the thin client device, the virtual desktop request including an identifier of the virtual desktop from a plurality of virtual desktops, the broker module configured to initiate, based on the identifier, a communication session between the thin client operating system and the server module.

18. The apparatus of claim 15, wherein the boot module is configured to receive a boot request signal from the thin client device having as its only nonvolatile memory a nonvolatile basic input/output system (BIOS) memory.

19. The apparatus of claim 15, wherein the boot module is configured to send the thin client operating system image to the thin client device such that the thin client device can store the thin client operating system image in a volatile memory at the thin client device.

20. The apparatus of claim 15, further comprising:
a control module executed at the hypervisor within the housing, the control module configured to manage at least one of the boot module or the server module, the control module configured to provide a user interface (UI) to a user such that the user can manage at least one of the boot module or the server module using the UI.

21. The apparatus of claim 15, wherein the boot module is configured to receive a boot request signal from the thin client device when the thin client device is activated, the boot module configured to send the thin client operating system image to the thin client device in response to the boot request signal.

22. The apparatus of claim 15, wherein the server module is configured to receive a plurality of commands from the thin client operating system and is configured to send a plurality of commands to the thin client operating system via a communication session between the thin client operating system and the server module.
